(19) United States
(12) Patent Application Publication
(10) Pub. No.: US 2010/0176543 A1
(43) Pub. Date: Jul. 15, 2010

(54) Sign Pole Guard

(76) Inventors: Kenneth Burke, Long Branch, NJ (US); Kris Mistretta, Monmouth Beach, NJ (US); Timothy Regan, Ocean, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 12/353,559

(22) Filed: Jan. 14, 2009

(51) Int. Cl. F16F 1/36

(52) U.S. Cl. 267/153

(57) ABSTRACT

A sign pole guard designed to encapsulate a U-channel metal sign post with a sheet of transparent, flexible material having a reflective covering to provided better visibility and an added layer of protection for individuals who may come into physical contact with the sign post itself. In addition, the sign pole guard comprises a strip of transparent, flexible material to be affixed to the edging of a metal street sign for added protection.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING

Not applicable.

### FIELD OF INVENTION

The present invention relates generally to a sign pole guard. More specifically, the within invention relates to a sign pole guard which is used to securely wrap a U-channel metal sign post and metal sign to provide increased visibility and to better protect the public from injury.

### BACKGROUND OF THE INVENTION

The traditional street sign comprises a standard U-channel metal sign post with a metal sign placard attached. U-channel metal sign posts are quite common and are used by cities and municipalities nationwide and are customarily placed next to roadways, sidewalks, schools, playgrounds, parks and recreational areas and other high traffic areas. One of the reasons that the U-channel metal sign post design is so popular is that it is cost efficient and easy to install. A traditional U-channel metal sign post configuration comprises a U-channel metal base post, customarily three (3) feet in length which is placed into the ground to serve as an attachment base for a the U-channel metal sign post itself which customarily extends 8 to 10 ft top above ground. This traditional two post system was designed for safety purposes in that if the U-channel metal sign post where impacted by a motor vehicle, the U-channel metal sign post itself would break away upon impact, leaving the U-channel metal base post in place. However, there remains the inherent risk associated with the traditional U-channel metal sign post design, namely to pedestrians who may come into physical contact with the U-channel metal sign post and or metal street sign.

Most signs incorporate reflective properties and are easily visible. However, the U-channel metal sign posts to which the signs are attached might not be as distinguishable. This is especially true during evening and night time hours or when visibility is limited, such as in adverse weather conditions, creating the added risk that a pedestrian might come into physical contact with both the sign and the U-channel metal sign post to which the sign is attached causing the increased likelihood of injury. There is also the added possibility that in areas of high pedestrian traffic, such as school playgrounds or other recreational areas, children might inadvertently come into physical contact with the edges of a standard U-channel metal sign post and possibly sustain injury. Also, if a U-channel metal sign post is not properly maintained and exposed to the elements, there is the likelihood that the edges will become rusted, thus creating a more abrasive texture which could lead to the added possibility of laceration, abrasion and bruising to an individual if one were to come into physical contact with same.

In addition to the potential dangers associated with a U-channel metal sign post, there are similar risks to those individuals who might come into physical contact with the sharp edges of the metal sign itself.

While several sign and sign post coverings have been design and/or utilized in the past, there remains a long standing necessity for a U-channel metal sign post guard which, in addition to increasing the visibility of a traditional U-channel metal sign post, will provide added safety features in the event that an individual were to come in contact with a U-channel metal sign post and/or the potential sharp edging of a metal sign.

There are several U.S. patents, including but not limited to U.S. Pat. No. Des. 416,368, U.S. Patent Application U.S. 2002/0046538 A1 and U.S. Patent Application 2002/0124448 which reference and disclose padding and reflective elements. However, there are shortcomings, namely an easy to install and effective means of encapsulating a U-channel metal sign post and metal street sign in a manner to both increase visibility and provide an added protective barrier in the event that an individual where to come into physical contact with a U-channel metal sign post and/or metal street sign.

For example, U.S. Pat. No. Des. 416,368 claims an ornamental design for a padded wrapping apparatus. U.S. Patent Application 2002/0046538 A1 discloses a foam padded design to surround a standard sized lally column. U.S. Patent Application 2002/0124448 A1 references a reflective covering for a sign post. While these patents all reference and disclose a post covering of some sort, there are shortcomings, namely a failure to provide impact protection with the added benefit of a reflective capacity to reduce the potential for personal injury.

The within invention is designed to be wrapped around a traditional U-channel metal sign post so as to not only provide an added layer of protection to protect an individual from personal injury resulting from physical contact with a U-channel metal sign post and/or metal sign, but also to provide an added reflective capacity so as make to make the U-channel metal sign post itself more visible.

### SUMMARY OF INVENTION

In light of the foregoing disadvantages of the prior art, the present invention provides a sign pole guard that can be effectively used to encase a standard U-channel metal sign post so as to not only provide greater visibility but greater safety benefits as well. The present invention also provides for a protective strip to be applied to the edge of a metal sign itself for added safety benefits. The sign pole guard having features of the of the present invention comprises a sheet of transparent, flexible material that is wrapped around a standard U-channel metal sign pole so as to fully encapsulate said U-channel metal sign pole. The sign pole guard has two perforated edges that overlap when the sign pole guard is wrapped around a U-channel metal sign post which would allow for the sign pole guard to be affixed to the U-channel metal sign post by plastic rivets which would pass through the overlapping perforated edges of the sign post guard and into the U-channel metal sign pole itself providing for a secure attachment. Plastic rivets are used in lieu of standard metal bolts to address additional safety concerns, namely the risk of injury often associated with protruding metal bolts. The front of the sign pole guard comprises a reflective cover strip down the entire length of the sleeve to provide for greater visibility of the U-channel metal sign post. The sign pole guard also incorporates a transparent, flexible material that is designed to be adhered to the edging of a sign so as to avoid the risk of injury if one were to come into physical contact with the edging of the metal sign itself. In the preferred embodiment of the invention, the transparent, flexible material is polypropylene.

It is understood that the invention is not limited in its application as set forth in the following description and drawings. The invention is capable of other embodiments and to be utilized in different ways. The phraseology and terminology employed is for the purposes of a description and should not be interpreted as limited.

### DESCRIPTION OF THE DRAWINGS

These and other features, aspects and advantages of the present invention will become better understood with regard to the following description, appended claims, and accompanying drawings where:

FIG. 1 is a rear perspective view of the preferred embodiment of the sign post guard in use on a U-channel metal sign post.

FIG. 2 is a front perspective view of the sign post guard in use as shown in FIG. 1.

FIG. 3 is a rear perspective view of the preferred embodiment of the sign post guard.

FIG. 4 is a perspective view of the preferred embodiment of the sign post guard in the unfolded position.

FIG. 5A is a top, cross sectional view of the preferred embodiment of the sign post guard in use attached to a U-channel metal sign post with exploded view of attachment means.

FIG. 5B is a top, cross sectional view of the preferred embodiment of the sign post guard in use attached to a U-channel metal sign post.

FIG. 6A is a rear perspective view of another embodiment of the sign post guard in use on a U-channel metal sign post and metal street sign.

FIG. 6B is a front perspective view of the sign post guard in use shown in FIG. 6A.

### DESCRIPTION OF THE PREFERRED EMBODIMENT

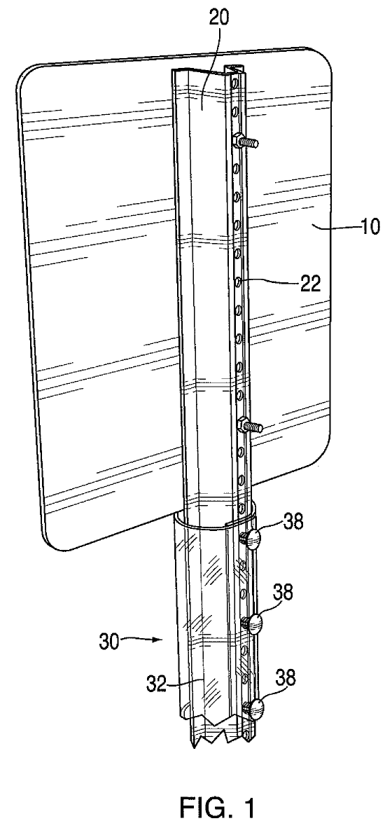

With reference to the drawings, a new and improved sign pole guard will be described in the following drawings, FIGS. 1-6B.

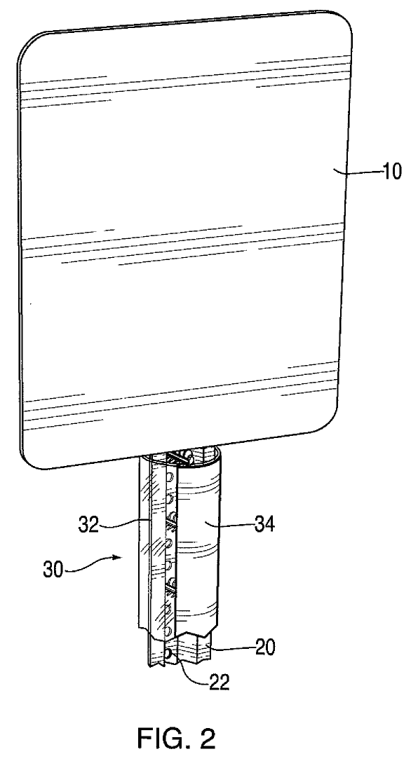

Referring to FIGS. 1-2, is the preferred embodiment of the invention in use wherein the sign pole guard (30) is comprised of a sheet of transparent, flexible material (32) that is wrapped around a standard U-channel metal sign post (20) and attached to a standard U-channel metal sign post (20) by way of plastic rivets (38) which pass through the overlapping sides of the sheet of transparent, flexible material (32) and through the pre-defined holes (22) in the standard U-channel metal sign post (20). In the preferred embodiment of the invention, the sheet of transparent, flexible material (32) is comprised of polypropylene and the rivets (38) are comprised of plastic.

FIG. 2 depicts the sign pole guard (30) of FIG. 1 from a frontal view with the sign pole guard (30) having a reflective strip (34) which is placed on the front of the sign pole guard (30) to better enhance the visibility of the U-channel metal sign post (20).

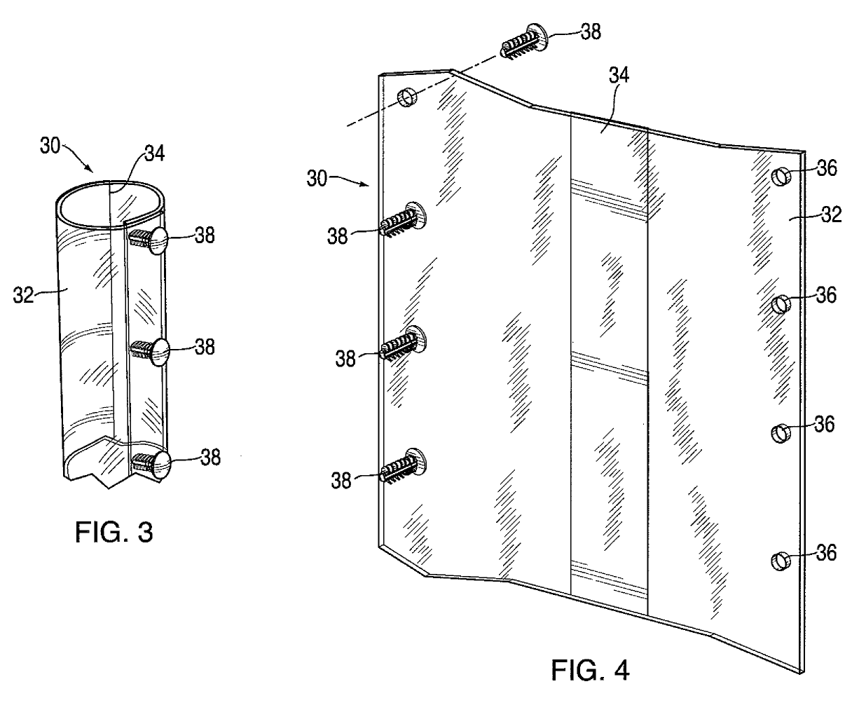

FIG. 3 demonstrates the sign pole guard (30) having a reflective strip (34) in the front of the sign pole guard (30) with plastic rivets (38) passing through the overlapping sides of the sheet of transparent, flexible material (32) as an attachment means for securing the sign post guard (30).

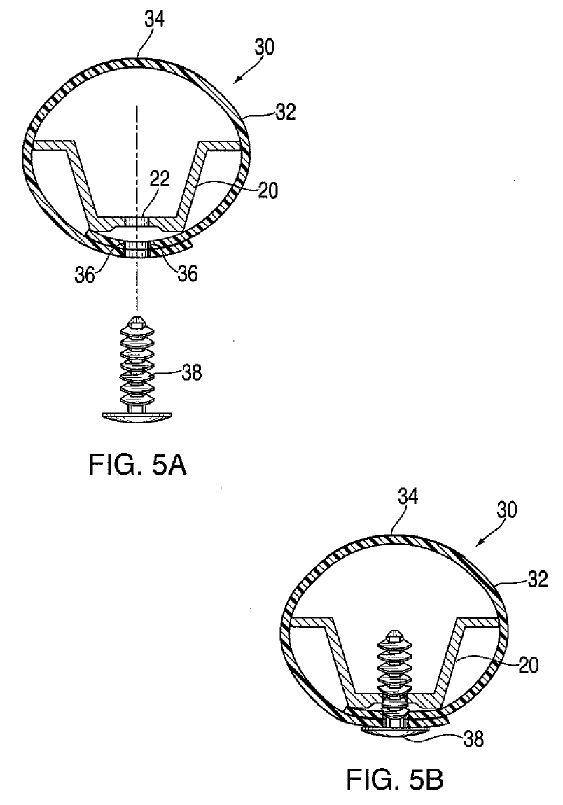

FIG. 4 shows the sheet of transparent, flexible material (32) in an unfolded position having a reflective strip (34) and a plurality of uniformly spaced openings (36) to accept a plastic rivet (38). The sheet of transparent, flexible material (32) is designed to be wrapped around a standard U-channel metal sign post (20) as shown in FIGS. 1-2 wherein the uniformly spaced openings (36) overlap and align so that plastic rivets (38) can be inserted through the uniformly spaced openings (36) as a securing means.

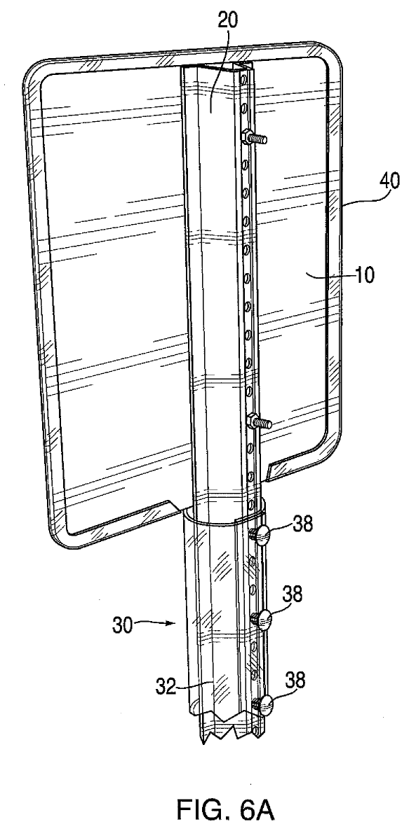

FIGS. 5A and 5B are cross sectional views showing the attachment means of the sign post guard (30) to a U-channel metal sign post (20). In FIG. 5A, the sheet of transparent, flexible material (32) is wrapped around a U-channel metal sign post (20) wherein the sides of the sheet of transparent, flexible material (32) overlap so as to allow the uniformly spaced openings (36) to align whereby a plastic rivet (38) would be inserted through the aligning uniformly spaced openings (36) and through a pre-defined opening (22) of the U-channel metal sign post (20). FIG. 5A also demonstrates the reflective strip (34) which is located in the front of the sign pole guard (30). FIG. 5B demonstrates a cross-sectional view wherein the sign pole guard (30) is affixed to a U-channel metal sign post (20).

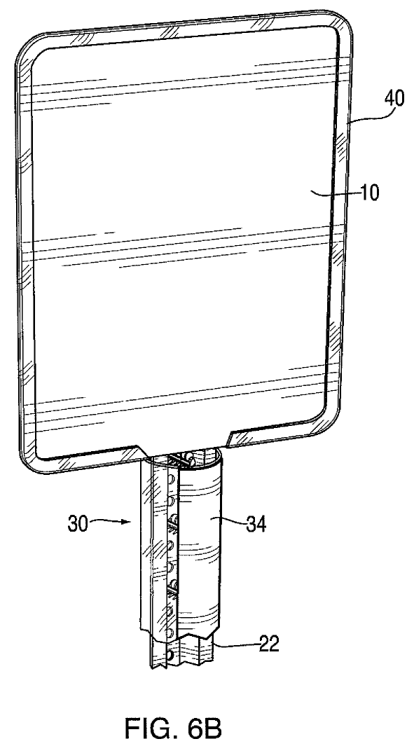

FIGS. 6A and 6B depict the sign pole guard as in FIGS. 1 and 2 with an additional embodiment of the invention wherein a strip of transparent, flexible material (40) is attached to the edge of a metal sign (10) to fully cover the exposed edging of the metal sign (10) for added protection. The strip of transparent, flexible material (40) is comprised of polypropylene.

While the preferred embodiments of the present invention has been described in considerable detail as noted above, it will be well recognized and understood that various modifications may be made with the appended claims intended to cover all such modifications which may fall within the intended scope of the invention. Therefore, the spirit and scope of the appended claims should not be limited to the description of the preferred versions contained herein.

What is claimed is:

1) A sign pole guard comprising:
a sheet of transparent, flexible material, said sheet having an inner surface and an outer surface with said inner surface positioned against a U-channel metal sign post, wherein said sheet is wrapped around to fully encapsulate a U-channel metal sign post, said sheet having a front and a back, wherein said front comprises a reflective cover, said sheet having two side edges, a first side edge and a second side edge wherein said first and second side edges comprise a plurality of uniformly spaced openings to accept a fastening means for securing said sheet to a U-channel metal sign post, wherein said first side edge would overlap said second side edge so as to align said openings of said first side edge with said openings of said second side edge wherein a fastening means would be inserted through said openings to secure said sheet to a U-channel metal sign post.

2) The sign pole guard of claim 1 wherein said fastening means is a plastic rivet.

3) The sign pole guard of claim 1 wherein said sheet transparent, flexible material is polypropylene.

4) A sign pole guard comprising:
a sheet of transparent, flexible material, said sheet having an inner surface and an outer surface with said inner surface positioned against a U-channel metal sign post, wherein said sheet is wrapped around to fully encapsulate a U-channel metal sign post, said sheet having a front and a back, wherein said front comprises a reflective cover, said sheet having two side edges, a first side edge and a second side edge wherein said first and second side edges comprise a plurality of uniformly spaced openings to accept a fastening means for securing said sheet to a U-channel metal sign post, wherein said first side edge would overlap said second side edge so as to align said openings of said first side edge with said openings of said second side edge wherein a fastening means would be inserted through said openings to secure said sheet to a U-channel metal sign post, and a strip of transparent, flexible material, said strip having a slit to accept an edge of a metal sign so that the edge of said metal sign is completely covered by said strip.

5) The sign pole guard of claim 4 wherein said fastening means is a plastic rivet.

6) The sign pole guard of claim 4 wherein said sheet of transparent, flexible material is polypropylene.

7) The sign pole guard of claim 4 wherein said strip of transparent, flexible material is polypropylene.
